(19) United States
(12) Patent Application Publication
(10) Pub. No.: US 2024/0169196 A1
(43) Pub. Date: May 23, 2024

(54) AUTO-SCALABLE SYNTHETIC DATA GENERATION-AS-A-SERVICE

(71) Applicant: Intrinsic Innovation LLC, Mountain View, CA (US)

(72) Inventors: Olivier Pauly, Munich (DE); Stefan Hinterstoisser, Munich (DE); Martina Marek, Muenchen (DE); Martin Bokeloh, Muenchen (DE); Hauke Heibel, Hohenkirchen-Siegertsbrunn (DE); Stefan Sauer, Neufahrn (DE)

(21) Appl. No.: 17/993,771

(22) Filed: Nov. 23, 2022

(51) Int. Cl. G06N 3/08

(52) U.S. Cl. CPC G06N 3/08

(57) ABSTRACT

Methods, systems, and apparatus, including computer programs encoded on computer storage media, for generating synthetic data to be used in training machine learning models in an auto-scalable manner. In one aspect, an auto-scalable synthetic data generation system maintains a plurality of synthetic data generator replicas that are each configured to generate synthetic training examples; maintains a plurality of machine learning training workers that are each configured to obtain synthetic training examples and to use the synthetic training examples to concurrently perform operations required to update the machine learning model; determines, by an autoscaler of the synthetic data generation system, that a number of synthetic data generator replicas is insufficient to service a current demand level of the plurality of machine learning training workers; and in response, deploys, by the autoscaler, one or more additional synthetic data generator replicas in the synthetic data generation system.

### BACKGROUND

This specification relates to training neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Synthetic data, which includes for example synthetic images and automatically generated labels, has been utilized in training such models. Synthetic data can be advantageous. For example, synthetic data can be generated in large volumes at a relatively low cost and has fewer labeling errors when compared with real data that includes real images and human-assigned labels.

### SUMMARY

This specification describes a system implemented by one or more computers that can generate synthetic data to be used in training machine learning models in an auto-scalable manner.

In a cloud-based computing environment, computing resources can be allocated to execute a workload. A “workload” may refer to any particular type and/or amount of work to be performed by computing resources. In this specification, dynamically adding and removing the allocated computing resources based on the actual demand level of the workload is referred to as auto-scaling. This is because the resources available to a particular workload are automatically scaled to match the data demand of the workload over time. For example, as the volume of inputs processed by the workload changes over time, more or fewer resources may be needed to generate such inputs to feed to the workload.

Particular embodiments of the subject matter described in this specification can be implemented so as to realize one or more of the following advantages. By using the auto-scaling techniques described in this specification, a cloud-based training system alleviates the problem of resource starvation that would be common in some existing training systems that train a machine learning model using synthetic data by way of feeding the model with a constant stream of data been generated on-the-fly regardless of the actual consumption speed of the data by the model that is being trained. Resource starvation happens when at least some of the computing resources (e.g., processing cores and memory) allocated to the actual training of the model are in an idle state because they are awaiting new training data to become available for training the model.

In particular, by using the auto-scaling techniques described in this specification, the cloud-based training system can scale up the number of synthetic data generator replicas depending on how fast synthetic data is consumed by the machine learning model that is being trained, thereby avoiding the synthetic data generation step (which can for example include computationally expensive image rendering and augmentation operations) from becoming a bottleneck during the training process that leads to resource starvation. In this way, the utilization of processing cores during training the model can be improved, as resource starvation is alleviated. The amount of memory required for storing the synthetic data can be reduced, as an appropriate amount of the synthetic data generated on-the-fly will be immediately consumed by the training process, eliminating the need for storing excessive amounts of data. And the time required for the training to converge can be reduced.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example cloud-based training system.

FIG. 2 is a diagram illustrating functional modules of an example machine learning compute instance.

FIG. 3 is a flow diagram of an example process for deploying one or more additional synthetic data generator replicas in an auto-scalable synthetic data generation system.

FIG. 4 is a flow diagram of an example process for obtaining synthetic training examples generated by the one or more additional synthetic data generator replicas.

Like reference numbers and designations in the various drawings indicate like elements.

### DETAILED DESCRIPTION

This specification describes a distributed system implemented by a plurality of computers that can generate synthetic data to be used in training machine learning models in an auto-scalable manner.

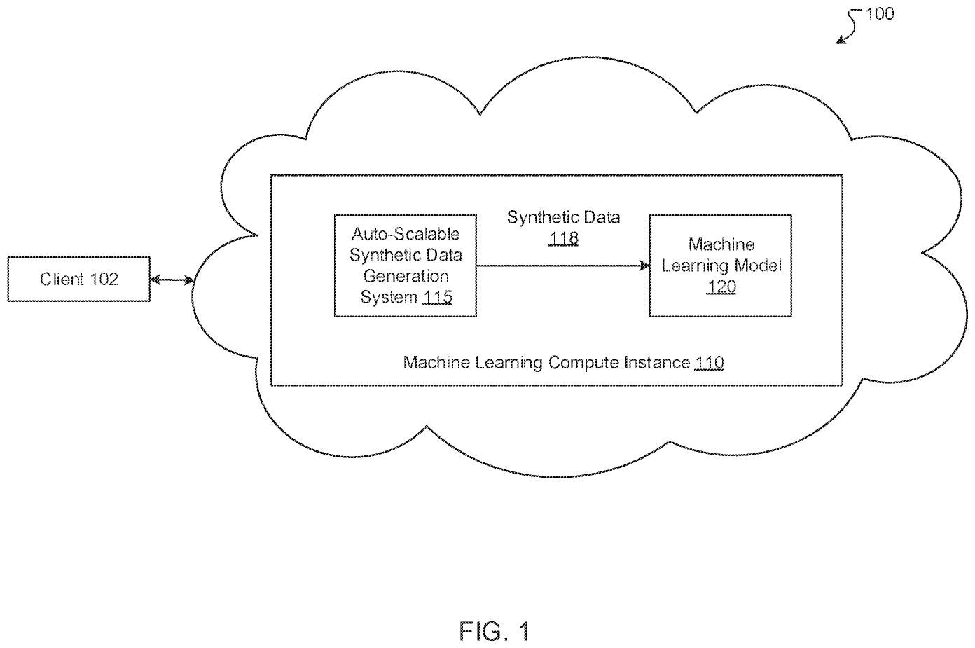

FIG. 1 shows an example cloud-based training system 100. The cloud-based training system 100, which typically includes hundreds or thousands of computing units hosted within a data center, can have large amounts of computing resources (e.g., processing cores, memory, storage, network, and so on) for execution of workloads submitted into the system 100.

The workload submission can be performed by one or more clients, e.g., client 102, over a data communication network. The client 102 can for example be a personal computer (PC), a local workstation or a local server having relatively small processing and memory resources. The client can provide an interface to a developer. The interface can be a command-line interface (CLI), graphical user interface (GUI), or various combinations of the two and possibly another user interface (e.g., a web browser as user interface), through which the developer can develop a machine learning model, e.g., the machine learning model 120, including the architecture of the model and the algorithms for training the model.

During the development of the machine learning model 120, the client 102 can issue a request for the cloud-based training system 100 to provide computing resources for a machine learning workload, e.g., to execute the training for the model or computing an inference using the model. In response to the request, the cloud-based training system 100 instantiates a machine learning compute instance 110. Instantiating a compute instance, such as a virtual machine, container, or the like, generally includes reserving computing resources of the underlying cloud-based training system 100 and making the reserved computing resources available to the client 102 for performing the machine learning workload requested by the client.

Thus, the developer may utilize the machine learning compute instance 110 hosted by the cloud-based training system 100 with much more computing resources than the client 102 to execute a machine learning workload during the development of the machine learning model 120, may save a lot of time, be more productive and may allow a better use of the available computing resources.

As an example for illustration, the developer may submit a machine learning workload that includes or otherwise identifies any kind of digital data input, and the system 100 can generate as output data any kind of score, classification, regression, or generative output by virtue of using a machine learning model deployed at, or accessible by, the system 100 to process the input. As another example for illustration, the developer may submit a machine learning workload that includes or otherwise identifies training data, and the system 100 can train a machine learning model, e.g., a neural network, on the training data to generate output data specifying a trained instance of the model capable of computing a desired prediction for a particular machine learning task. For example, the system 100 can provide the output data specifying the trained model, e.g., the trained values of the parameters of the neural network and data specifying the architecture of the neural network, to the client 102 which submitted the workload.

In some cases, the lifetime of such a machine learning compute instance 110 is the same as the lifetime of the training of a particular machine learning model, e.g., the machine learning model 120. This means that the compute instance 110 may be launched at the beginning of the training workload and stopped when execution of the training workload is completed.

The machine learning model 120 can be trained to perform any kind of machine learning task, i.e., to receive any kind of digital data input and to generate any kind of score, classification, or regression output based on the input. The machine learning model 120 is typically a neural network, although other architectures are also possible, e.g., support vector machine, kernel estimation (e.g., k-nearest neighbor), boosting, decision trees (e.g., random forests), and so on.

In some cases, the neural network is configured to perform an image processing task, i.e., receive an input image and to process the input image to generate a network output for the input image. In this specification, processing an input image refers to processing the intensity values of the pixels of the image using a neural network. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As another example, the task can be object detection and the output generated by the neural network can identify locations in the input image at which particular types of objects are depicted. As another example, the task can be image segmentation and the output generated by the neural network can define for each pixel of the input image which of multiple categories the pixel belongs to. As yet another example, the task can be a pose detection task for estimating the pose of objects in input images. Generally, the pose of an object is a combination of the position and orientation of the object in the input image. For example, the neural network can generate as the network output a pose vector that includes an estimated location in the image of each of a predetermined number of keypoints of the object, such as body joints of the human body.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent. The observations can include sensor data captured by sensors measuring the environment, e.g., camera sensors, Lidar sensors, temperature sensors, humidity sensors, and so on. The output can be an action vector that specifies commands, e.g., torques, to be applied to various controllable aspects, e.g., joints, of the robot. Additionally or alternatively, the output can be a pose vector that specifies parameters of a target pose that an end effector of the robot should have.

As another example, if the inputs to the neural network are Internet resources (e.g., web pages), documents, or portions of documents or features extracted from Internet resources, documents, or portions of documents, the task can be to classify the resource or document, i.e., the output generated by the neural network for a given Internet resource, document, or portion of a document may be a score for each of a set of topics, with each score representing an estimated likelihood that the Internet resource, document, or document portion is about the topic.

As another example, if the inputs to the neural network are features of an impression context for a particular advertisement, the output generated by the neural network may be a score that represents an estimated likelihood that the particular advertisement will be clicked on.

As another example, if the inputs to the neural network are features of a personalized recommendation for a user, e.g., features characterizing the context for the recommendation, e.g., features characterizing previous actions taken by the user, the output generated by the neural network may be a score for each of a set of content items, with each score representing an estimated likelihood that the user will respond favorably to being recommended the content item.

As another example, if the input to the neural network is a sequence of text in one language, the output generated by the neural network may be a score for each of a set of pieces of text in another language, with each score representing an estimated likelihood that the piece of text in the other language is a proper translation of the input text into the other language.

As another example, if the input to the neural network is a sequence representing a spoken utterance, the output generated by the neural network may be a score for each of a set of pieces of text, each score representing an estimated likelihood that the piece of text is the correct transcript for the utterance.

As another example, the task may be an audio processing task. For example, if the input to the neural network is a sequence representing a spoken utterance, the output generated by the neural network may be a piece of text that is a predicted correct transcript for the utterance. As another example, if the input to the neural network is a sequence representing a spoken utterance, the output generated by the neural network can indicate whether a particular word or phrase (“hotword”) was spoken in the utterance. As another example, if the input to the neural network is a sequence representing a spoken utterance, the output generated by the neural network can identify the natural language in which the utterance was spoken.

As another example, the task can be a natural language processing or understanding task, where the input is a sequence of text in a natural language and the output is a natural language processing or understanding output. One example of such a task is an entailment task, where the input includes a plurality of natural language statements and the output indicates an entailment between the statements. Another example is a paraphrasing task, where the input is a natural language sequence and the output identifies another natural language sequence that has a similar meaning to the input sequence. Another example is a textual similarity task, where the input is a plurality of natural language sequences and the output indicates how similar, e.g., semantically similar, the input sequence are. Another example is a sentiment task, where the input is a natural language sequence and the output characterizes a sentiment of the input sequence. Another example is a sentence completion task, where the input is a natural language sequence and the output identifies another natural language sequence that is a completion of the input sequence. Another example is a summarization task, where the input is an input natural language text sequence and the output is a summary natural language sequence that is shorter than the input sequence but summarizes the input sequence, i.e., represents the most important or relevant information within the input sequence. In some cases, the summarization task is an extractive summarization task, where the output sequence is a proper subset of the input sequence, i.e., is made up of text from the input sequence. In some other cases, the summarization task is an abstractive summarization task, where the output is a new sequence that can contain different text from the input sequence. Another example is a grammaticality task, where the input is an input natural language text sequence and the output characterizes the grammaticality of the input sequence, i.e., how grammatically correct the input sequence is.

As another example, the task can be a text to speech task, where the input is text in a natural language or features of text in a natural language and the network output is a spectrogram, a waveform, or other data defining audio of the text being spoken in the natural language.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input. As yet another example, the input to the text generation task can include both text and input from a different modality, and the output sequence can be text that responds to the input. For example, the task can be a visual question answering task, and the input can include one or more images and a text question about the one or more images, and the output sequence can be an answer to the text question.

As another example, the task can be an image generation task, where the input is a conditioning input and the output is a sequence of intensity value inputs for the pixels of an image. The conditioning input can include one or more of, e.g., a class label identifying a desired category of object that should be pictured in the image, a text sequence describing the desired content of the image, or another image, e.g., an image of an object that should be included in the new image or a lower-resolution image that should be upscaled to a higher resolution to generate the new image.

In some cases, the machine learning task is a combination of multiple individual machine learning tasks, i.e., the neural network is configured to perform multiple different individual machine learning tasks, e.g., two or more of the machine learning tasks mentioned above. For example, the neural network can be configured to perform multiple individual natural language understanding tasks. Optionally, the network input can include an identifier for the individual natural language understanding task to be performed on the network input. As another example, the neural network can be configured to perform multiple individual image processing or computer vision tasks, i.e., by generating the output for the multiple different individual image processing tasks in parallel by processing a single input image.

Real data can be utilized in training the machine learning model 120. Real data can include real images, audio, text, and the like, as well as corresponding human-assigned labels (e.g., labeled bounding box(es) or other annotations). Instead of or in addition to real data, synthetic data can be utilized in training the machine learning model 120. Synthetic data can include synthetic images, audio, text, and the like, as well as automatically assigned labels. Synthetic data is typically generated rather than captured. For example synthetic data can include data regarding a synthetic scene, such as view and/or image data, as opposed to a scene that exists in the real world. Synthetic data can also include augmented data (e.g., flipped/translated/rotated images, obfuscated/masked text, and so on), noise data, randomized data, unlabeled data, or another type of synthetic data.

During training, such synthetic data will be generated by an auto-scalable synthetic data generation system 115 that executes on the machine learning compute instance 110. The auto-scalable synthetic data generation system 115 can generate the synthetic data 118 on-the-fly (that is, while the training of the model 120 continues) such that new synthetic data 118 is used to update the machine learning model 120 as the data becomes available.

As will be described further below, depending on how fast the synthetic data 118 is consumed (i.e., processed) by the machine learning model 120 that is being trained, the cloud-based training system 100 can adaptively determine different amounts of computing resources to utilize in the generation of the synthetic data 118 by the auto-scalable synthetic data generation system 115 to be fed to the machine learning model 120.

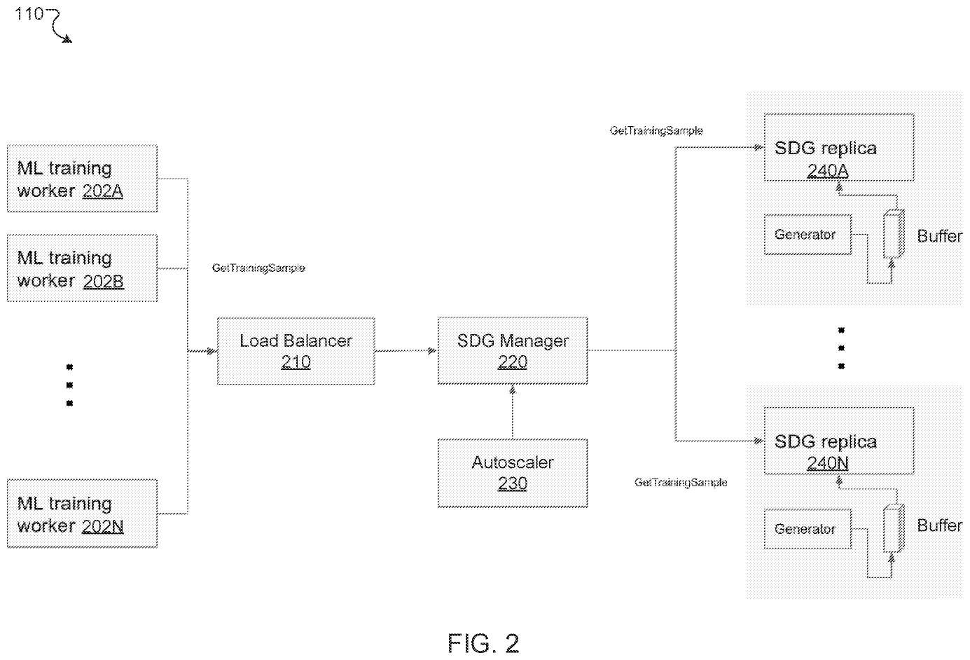

FIG. 2 is a diagram illustrating functional modules of an example machine learning compute instance. For example, the machine learning compute instance can be the machine learning compute instance 110 of FIG. 1 in which a machine learning model 120 is trained by using synthetic data 118 generated by an auto-scalable synthetic data generation system 115.

As shown, a plurality of machine learning training workers 202A-N execute on the machine learning compute instance. Each of the machine learning training workers 202A-N is implemented as one or more computer programs and data deployed to be executed on a respective computing unit. The computing units are configured so that they can operate independently of each other. In some implementations, only partial independence of operation is achieved, for example, because workers share some resources. A computing unit may be, e.g., a computer, a core within a computer having multiple cores, or other hardware or software within a computer capable of independently performing the computation for a worker.

Each of the plurality of machine learning training workers 202A-N can apply an iterative process for updating the parameters of the machine learning model 120 to determine trained values for the parameters of the model in accordance with training data that includes the synthetic data 118. The workers can for example apply a gradient descent (and, in the case of a neural network, backpropagation) technique to optimize an objective function that is appropriate for the task that the model is configured to perform. Each worker can operate independently (and, in some cases, asynchronously) from each other worker. During training, the machine learning training workers can incorporate any number of techniques to improve the speed, the effectiveness, or both of the training process. For example, the workers can use data parallelism, model parallelism, or both to increase the speed of the training process. As another example, the workers can first pre-train the machine learning model through unsupervised learning, e.g., to minimize a reconstruction loss or other unsupervised loss, and then fine-tune the machine learning model to optimize the objective function for the task.

A load balancer 210 exposes an application program interface (API) or another data interface that is used by each of the plurality of machine learning training workers 202A-N to obtain the synthetic data. For example, the API can be an API that receives data fetch requests (“GetTrainingSample”) from the machine learning training workers 202A-N. The load balancer 210 can route the data fetch requests (“GetTrainingSample”) received from the plurality of machine learning training workers 202A-N to the multiple different synthetic data generator replicas 240A-N that are currently executing on the machine learning compute instance. In some cases, the load balancer 210 can operate in a session persistence mode where the data fetch requests from the same machine learning training worker will be consistently directed to the same synthetic data generator replica; thus, a machine learning training worker will always receive synthetic data generated by one synthetic data generator replica for use in the training. In other cases, the load balancer 210 can randomize the routing of the data fetch requests from the machine learning training workers 202A-N to the synthetic data generator replicas 240A-N; thus a machine learning training worker will receive synthetic data generated by multiple different synthetic data generator replicas, such that over the course of the training each worker can receive training data with greater diversity that has been generated by a pool of many different replicas.

In particular, at each iteration, a given machine learning training worker, e.g., worker 202A, can obtain synthetic data in the form a batch of one or more synthetic training examples generated by one or more of the synthetic data generator replicas 240A-N by making a data fetch request (“GetTrainingSample”) to the load balancer 210, which is routed by the load balancer to a corresponding synthetic data generator replica, and then use the batch of synthetic training examples obtained from the corresponding synthetic data generator replica to update the parameters of machine learning model 120 based on a gradient of the objective function computed with respect to the parameters that measures a difference between (i) the outputs of the model generated from processing the synthetic training examples and (ii) the labels associated with these examples.

As shown, a plurality of synthetic data generator (SDG) replicas 240A-N execute on the machine learning compute instance. Like the machine learning training workers, each of the synthetic data generator replicas 240A-N is implemented as one or more computer programs and data deployed to be executed on a respective computing unit, and can thus operate independently (and, in some cases, asynchronously) from each other replica. Each synthetic data generator replica includes a synthetic data generator that is configured to generate synthetic training examples for training the machine learning model 120 to perform the task. Each synthetic data generator may, but need not, generate the same type of synthetic training examples as each other generator. For example one generator can generate labeled synthetic training examples (e.g., synthetic images with associated ground truth labels), while another generator can generate unlabeled synthetic training examples (e.g., synthetic images for which no ground truth labels are available). The synthetic data generators can apply any suitable technique or combination of techniques to improve the quality, the diversity, or both of the synthetic training examples to ensure the overall effectiveness of the training. By way of illustration and not limitation, the synthetic data generators can apply the image layer blending techniques described in more detail at https://arxiv.org/pdf/1902.09967.pdf for creating synthetic training examples (where each example is a synthetic image) for object instance detection tasks.

Each synthetic data generator replica has an associated buffer for storing synthetic training examples that have been generated by the synthetic data generator and that are pending to be processed by the machine learning training workers. Each buffer can be a queue, a list, or another data structure that is implemented in a storage or memory accessible by a respective synthetic data generator replica. For example, each buffer can be a queue that is maintained on the same computing unit as a respective one of the plurality of synthetic data generator replicas 240A-N. Each synthetic data generator replica is configured to continually place generated synthetic training examples in a respective buffer associated with the synthetic data generator replica, e.g., by way of enqueuing the examples (or a pointer, identifier, or some other reference to the examples) to a respective queue.

Once the routing of the data fetch requests is completed by the load balancer 210, the plurality of machine learning training workers 202A-N can fetch the pending synthetic training examples stored within the respective buffers of the plurality of synthetic data generator replicas 240A-N in accordance with the routing. From each respective buffer, a machine learning training worker can for example obtain a fixed number of synthetic training examples in a first-in-first-out (FIFO) manner (where the examples that have been pending for the longest period of time are fetched first), a last-in-first-out (LIFO) manner, or any other suitable data fetch manner.

A synthetic data generator (SDG) manager 220 manages the plurality of synthetic data generator (SDG) replicas 240A-N that execute on the machine learning compute instance. In particular, the SDG manager 220 uses an autoscaler 230 to dynamically adjust the number of SDG replicas that execute on the compute instance based on various performance metrics monitored by the SDG manager 220 to ensure that there is a sufficient number of synthetic training examples to service a current demand level of the plurality of machine learning training workers 202A-N. The performance metrics can include, for example, the number of data fetch requests received, the sizes of the buffers that store synthetic training examples, the utilization rate of the computing resources allocated to the machine learning compute instance, and so on. Generally, the SDG manager 220 can use the autoscaler 230 to add additional SDG replicas (to execute on respective additional computing units) when the synthetic training examples are relatively quickly consumed by the workers 202A-N that use these examples to train the machine learning model, and to remove existing SDG replicas when the synthetic training examples are relatively slowly consumed by the workers 202A-N.

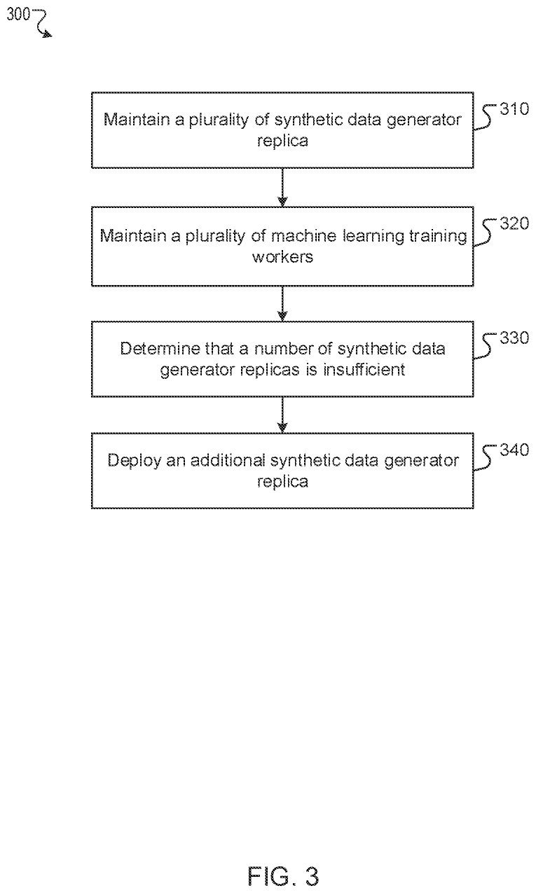

FIG. 3 is a flow diagram of an example process 300 for deploying one or more additional synthetic data generator replicas in an auto-scalable synthetic data generation system. For convenience, the process 300 will be described as being performed by a system of one or more computers located in one or more locations. For example, a distributed computing system, e.g., the cloud-based training system 100 of FIG. 1 that includes the auto-scalable synthetic data generation system 115, appropriately programmed in accordance with this specification, can perform the process 300.

The system maintains a plurality of synthetic data generator replicas (step 310). Each synthetic data generator replica is configured to generate synthetic training examples for training a machine learning model to perform a particular task. Each synthetic data generator replica is configured to continually place generated synthetic training examples in a respective buffer associated with the synthetic data generator replica, e.g., by way of enqueuing the examples (or a pointer, identifier, or some other reference to the examples) to a respective queue that is accessible by the replica. In some implementations, each synthetic data generator replica is configured to pause generation of synthetic training examples when above a threshold number of buffer locations in the associated buffer is filled (with pending synthetic training examples), and to resume generation of synthetic training examples when the associated buffer is no longer filled.

The system maintains a plurality of machine learning training workers (step 320). Each machine learning training worker is configured to obtain synthetic training examples generated by one or more of the synthetic data generator replicas and to use the synthetic training examples to concurrently perform operations required to update the machine learning model. Each machine learning training worker will usually obtain synthetic training examples generated by different synthetic data generator replicas at different iterations. In some implementations, such operations include iteratively applying a gradient descent (and, in the case of a neural network, backpropagation) technique to optimize an objective function that is appropriate for the particular task that the machine learning model is configured to perform. For example, the objective function can measure a difference between (i) the outputs of the model generated from processing the synthetic training examples and (ii) the labels associated with these examples.

The system determines, by using an autoscaler of the synthetic data generation system, whether a number of synthetic data generator replicas is sufficient to service a current demand level of the plurality of machine learning training workers (step 330). The system can make this determination as often as necessary to ensure efficient utilization of computing resources during the training process. For example, this determination can be repeated once a minute, or once ten minutes, or once an hour. This determination can also be triggered by the developer who submitted the workload request.

In some implementations, this can include computing a utilization metric based on the fullness of buffers for the synthetic data generation replicas. For example, the fullness can be defined in terms of a number of buffer locations that are filled (with pending synthetic training examples), in some cases relative to a pre-allocated size of the buffer. Such a metric indicates the average synthetic training example generation speed versus the average synthetic training example consumption speed. In these implementations, the determination that the number of synthetic data generator replicas is insufficient to service the current demand level of the plurality of machine learning training workers (and correspondingly, more synthetic data generation replicas are needed) will be made when the utilization metric computed based on the fullness drops below a threshold, indicating that the average synthetic training example generation speed is lower than the average synthetic training example consumption speed.

In some implementations, this can include computing a target number of synthetic data generator replicas that should run on the system based on buffer sizes and comparing the current number of synthetic data generator replicas that are currently running on the system to the target number. For example, the system can compute the target number of synthetic data generator replicas by computing a ratio of a target queue size to an observed queue size, multiplied by a number of synthetic data generation replicas, where the target number of synthetic data generator replicas target_num_replicas is given by:

target_num_replicas=ceil((target_queue_size/observed_queue_size)*num_replicas),
where target_queue_size is a predetermined queue fullness metric, observed_queue_size is a metric representing a current level of queue fullness, num_replicas is the current number of synthetic data generation replicas, and ceil is the ceiling function that rounds a number to the next higher integer. Like how the fullness is defined above, here the queue fullness can be defined in terms of a number of queue locations that are filled.

In response to determining that the number of synthetic data generator replicas is insufficient to service the current demand level of the plurality of machine learning training workers, the system instantiates and deploys, by using the autoscaler, one or more additional synthetic data generator replicas in the system (step 340). For example, the exact number of additional synthetic data generator replicas can be the difference between the current number of synthetic data generator replicas and the target number of synthetic data generator replicas determined at step 330. Once deployed, these additional synthetic data generator replicas will run concurrently with (although independently from) the plurality of synthetic data generator replicas that are already executing on the system.

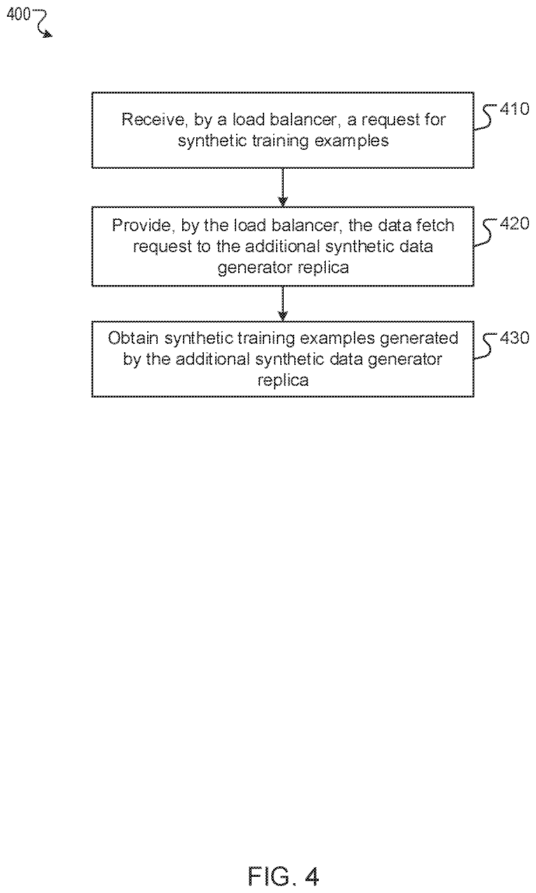

FIG. 4 is a flow diagram of an example process 400 for obtaining synthetic training examples generated by the one or more additional synthetic data generator replicas. For convenience, the process 400 will be described as being performed by a system of one or more computers located in one or more locations. For example, a distributed computing system, e.g., the cloud-based training system 100 of FIG. 1 that includes the auto-scalable synthetic data generation system 115, appropriately programmed in accordance with this specification, can perform the process 400.

The system receives, at a load balancer of the system, one or more requests for synthetic training examples from the plurality of machine learning training workers (step 410).

The system uses the load balancer to provide the one or more data fetch requests to one or more additional synthetic data generator replicas that are deployed and running on the system (step 420). The one or more additional replicas can be the replicas that have been deployed by performing process 300 described above. That is, the load balancer can route the data fetch requests received from the plurality of machine learning training workers not only to the plurality of synthetic data generator replicas already maintained by the system, but also to the one or more additional synthetic data generator replicas (that have been deployed in response to determining that the number of synthetic data generator replicas is insufficient to service the current demand level of the plurality of machine learning training workers).

The system obtains, by the plurality of machine learning training workers and in accordance with the routing, synthetic training examples including those examples generated by the one or more additional synthetic data generator replicas (step 430). The plurality of machine learning training workers will then use the synthetic training examples to concurrently perform operations required to update the machine learning model.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an operating environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is auto-scalable synthetic data generation system comprising a plurality of computers and a plurality of storage devices storing instructions that are operable, when executed by the computers, to cause the computers to perform operations comprising:
maintaining a plurality of synthetic data generator replicas that are each configured to generate synthetic training examples for training a machine learning model to perform a particular task;
maintaining a plurality of machine learning training workers that are each configured to obtain synthetic training examples generated by one or more of the synthetic data generator replicas and to use the synthetic training examples to concurrently perform operations required to update the machine learning model;
determining, by an autoscaler of the synthetic data generation system, that a number of synthetic data generator replicas is insufficient to service a current demand level of the plurality of machine learning training workers; and
in response, deploying, by the autoscaler, an additional synthetic data generator replica in the synthetic data generation system.

Embodiment 2 is the system of embodiment 1, wherein the operations further comprise:
receiving, by a load balancer for the plurality of machine learning training workers, a request for synthetic training examples;
providing, by the load balancer, the data fetch request to the additional synthetic data generator replica deployed in the synthetic data generation system; and
obtaining, by at least one of the plurality of machine learning training workers, synthetic training examples generated by the additional synthetic data generator replica deployed in the distributed synthetic data generation system.

Embodiment 3 is the system of any one of embodiments 1-2, wherein each synthetic data generator replica has a respective associated queue, and wherein the synthetic data generator replica is configured to continually place generated synthetic training examples in the queue.

Embodiment 4 is the system of embodiment 3, wherein each synthetic data generator replica is configured to pause generation of synthetic training examples when the associated queue is filled.

Embodiment 5 is the system of embodiment 4, wherein each synthetic data generator replica is configured to resume generation of synthetic training examples when the associated queue is no longer filled.

Embodiment 6 is the system of any one of embodiments 2-4, wherein determining, by the autoscaler of the synthetic data generation system, that a number of synthetic data generator replicas is insufficient to service a current demand level of the plurality of machine learning training workers comprises computing a utilization metric based on the fullness of queues for the synthetic data generation replicas.

Embodiment 7 is the system of any one of embodiments 2-4, wherein determining, by the autoscaler of the synthetic data generation system, that a number of synthetic data generator replicas is insufficient to service a current demand level of the plurality of machine learning training workers comprises computing a target number of synthetic data generator replicas based on queue sizes.

Embodiment 8 is the system of embodiment 7, wherein computing the target number of synthetic data generator replicas comprises computing a ratio of a target_queue_size to an observed_queue_size multiplied by a number of synthetic data generation replicas.

Embodiment 9 is the system of embodiment 8, wherein the target number of synthetic data generator replicas target_num_replicas is given by:

target_num_replicas=ceil((target_queue_size/observed_queue_size)*num_replicas),
where target_queue_size is a predetermined queue fullness metric, observed_queue_size is a metric representing a current level of queue fullness, and num_replicas is the current number of synthetic data generation replicas.

Embodiment 10 is a method comprising the operations that the auto-scalable synthetic data generation system of any one of claims 1-9 is configured to perform.

Embodiment 11 is a computer storage medium encoded with a computer program, the program comprising instructions that are operable, when executed by data processing apparatus, to cause the data processing apparatus to perform the operations that the auto-scalable synthetic data generation system of any one of claims 1-9 is configured to perform.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. An auto-scalable synthetic data generation system comprising a plurality of computers and a plurality of storage devices storing instructions that are operable, when executed by the computers, to cause the computers to perform operations comprising:
maintaining a plurality of synthetic data generator replicas that are each configured to generate synthetic training examples for training a machine learning model to perform a particular task;
maintaining a plurality of machine learning training workers that are each configured to obtain synthetic training examples generated by one or more of the synthetic data generator replicas and to use the synthetic training examples to concurrently perform operations required to update the machine learning model;
determining, by an autoscaler of the synthetic data generation system, that a number of synthetic data generator replicas is insufficient to service a current demand level of the plurality of machine learning training workers; and
in response, deploying, by the autoscaler, an additional synthetic data generator replica in the synthetic data generation system.

2. The system of claim 1, wherein the operations further comprise:
receiving, by a load balancer for the plurality of machine learning training workers, a request for synthetic training examples;
providing, by the load balancer, the data fetch request to the additional synthetic data generator replica deployed in the synthetic data generation system; and
obtaining, by at least one of the plurality of machine learning training workers, synthetic training examples generated by the additional synthetic data generator replica deployed in the distributed synthetic data generation system.

3. The system of claim 1, wherein each synthetic data generator replica has a respective associated queue, and wherein the synthetic data generator replica is configured to continually place generated synthetic training examples in the queue.

4. The system of claim 3, wherein each synthetic data generator replica is configured to pause generation of synthetic training examples when the associated queue is filled.

5. The system of claim 4, wherein each synthetic data generator replica is configured to resume generation of synthetic training examples when the associated queue is no longer filled.

6. The system of claim 4, wherein determining, by the autoscaler of the synthetic data generation system, that a number of synthetic data generator replicas is insufficient to service a current demand level of the plurality of machine learning training workers comprises computing a utilization metric based on the fullness of queues for the synthetic data generation replicas.

7. The system of claim 4, wherein determining, by the autoscaler of the synthetic data generation system, that a number of synthetic data generator replicas is insufficient to service a current demand level of the plurality of machine learning training workers comprises computing a target number of synthetic data generator replicas based on queue sizes.

8. The system of claim 7, wherein computing the target number of synthetic data generator replicas comprises computing a ratio of a target queue size to an observed queue size multiplied by a number of synthetic data generation replicas.

9. The system of claim 8, wherein the target number of synthetic data generator replicas target_num_replicas is given by:
target_num_replicas=ceil((target_queue_size/observed_queue_size)*num_replicas),
where target_queue_size is a predetermined queue fullness metric, observed_queue_size is a metric representing a current level of queue fullness, and num_replicas is the current number of synthetic data generation replicas.

10. A method performed by an auto-scalable synthetic data generation system, wherein the method comprises:
maintaining a plurality of synthetic data generator replicas that are each configured to generate synthetic training examples for training a machine learning model to perform a particular task;
maintaining a plurality of machine learning training workers that are each configured to obtain synthetic training examples generated by one or more of the synthetic data generator replicas and to use the synthetic training examples to concurrently perform operations required to update the machine learning model;
determining, by an autoscaler of the synthetic data generation system, that a number of synthetic data generator replicas is insufficient to service a current demand level of the plurality of machine learning training workers; and
in response, deploying, by the autoscaler, an additional synthetic data generator replica in the synthetic data generation system.

11. The method of claim 10, further comprising:
receiving, by a load balancer for the plurality of machine learning training workers, a request for synthetic training examples;
providing, by the load balancer, the data fetch request to the additional synthetic data generator replica deployed in the synthetic data generation system; and
obtaining, by at least one of the plurality of machine learning training workers, synthetic training examples generated by the additional synthetic data generator replica deployed in the distributed synthetic data generation system.

12. The method of claim 10, wherein each synthetic data generator replica has a respective associated queue, and wherein the synthetic data generator replica is configured to continually place generated synthetic training examples in the queue.

13. The method of claim 12, wherein each synthetic data generator replica is configured to pause generation of synthetic training examples when the associated queue is filled.

14. The method of claim 13, wherein each synthetic data generator replica is configured to resume generation of synthetic training examples when the associated queue is no longer filled.

15. The method of claim 13, wherein determining, by the autoscaler of the synthetic data generation system, that a number of synthetic data generator replicas is insufficient to service a current demand level of the plurality of machine learning training workers comprises computing a utilization metric based on the fullness of queues for the synthetic data generation replicas.

16. The method of claim 13, wherein determining, by the autoscaler of the synthetic data generation system, that a number of synthetic data generator replicas is insufficient to service a current demand level of the plurality of machine learning training workers comprises computing a target number of synthetic data generator replicas based on queue sizes.

17. The method of claim 16, wherein computing the target number of synthetic data generator replicas comprises computing a ratio of a target queue size to an observed queue size multiplied by a number of synthetic data generation replicas.

18. The method of claim 17, wherein the target number of synthetic data generator replicas target_num_replicas is given by:
target_num_replicas=ceil((target_queue_size/observed_queue_size)*num_replicas),
where target_queue_size is a predetermined queue fullness metric, observed_queue_size is a metric representing a current level of queue fullness, and num_replicas is the current number of synthetic data generation replicas.

19. A computer storage medium encoded with a computer program, the program comprising instructions that are operable, when executed by data processing apparatus, to cause the data processing apparatus to implement an auto-scalable synthetic data generation system configured to perform operations comprising:
maintaining a plurality of synthetic data generator replicas that are each configured to generate synthetic training examples for training a machine learning model to perform a particular task;
maintaining a plurality of machine learning training workers that are each configured to obtain synthetic training examples generated by one or more of the synthetic data generator replicas and to use the synthetic training examples to concurrently perform operations required to update the machine learning model;
determining, by an autoscaler of the synthetic data generation system, that a number of synthetic data generator replicas is insufficient to service a current demand level of the plurality of machine learning training workers; and
in response, deploying, by the autoscaler, an additional synthetic data generator replica in the synthetic data generation system.

20. The computer storage medium of claim 19, wherein the operations further comprise:
receiving, by a load balancer for the plurality of machine learning training workers, a request for synthetic training examples;
providing, by the load balancer, the data fetch request to the additional synthetic data generator replica deployed in the synthetic data generation system; and
obtaining, by at least one of the plurality of machine learning training workers, synthetic training examples generated by the additional synthetic data generator replica deployed in the distributed synthetic data generation system.
